(19) United States
(12) Patent Application Publication
(10) Pub. No.: US 2013/0166355 A1
(43) Pub. Date: Jun. 27, 2013

(54) DYNAMIC MULTI-DIMENSIONAL AND MULTI-VIEW PRICING SYSTEM

(71) Applicants: Santosh Kumar Mohanty, Mumbai (IN); Archan Ghosh, Mumbai (IN); Ayush Mahendru, Mumbai (IN); Himanshu Mehta, Mumbai (IN)

(72) Inventors: Santosh Kumar Mohanty, Mumbai (IN); Archan Ghosh, Mumbai (IN); Ayush Mahendru, Mumbai (IN); Himanshu Mehta, Mumbai (IN)

(73) Assignee: TATA CONSULTANCY SERVICES LIMITED, Maharashtra (IN)

(21) Appl. No.: 13/423,304

(22) Filed: Mar. 19, 2012

(30) Foreign Application Priority Data
Dec. 23, 2011 (IN) 3643/MUM/2011

(51) Int. Cl. G06Q 10/00

(52) U.S. Cl. 705/7.35; 705/7.11

(57) ABSTRACT

A system for dynamic computing a credible deal price for a deal is adapted to receive a first data set during initializing the deal parameters. The system comprising a plurality of stakeholders inputting their views as a second data set through a presentation layer module. A preliminary information processing module configured to process the first data set and a plurality of pricing models for determining an optimum deal price for the deal using the first & second data set and associated context related therewith. A pricing strategy module configured to process a one or more inputs of the second data set to determine a list price indicator, wherein a list price generator module configured to determine the credible deal price. A deal negotiation module optimizes the credible deal price commensurate with plurality of third data set dynamic associated in time, space and values therewith the deal.

### FIELD OF INVENTION

The present invention generally relates to a field of pricing and more particularly to a computing model integrating multiple stakeholders' views with pricing models for determining a justifiable pricing in compliance with multiple business dynamics thereof for a deal under deliberation.

### BACKGROUND OF THE INVENTION

For every organization, the right pricing for its offerings is extremely important to achieve the right balance towards growth, profitability, investments and stay competitive in the marketplace. Many business decisions are made based on price, irrespective of whether companies directly sell to end-consumers or to other businesses. While making a business decision, for a corporation, a desire for healthy margin coupled with ever-changing competitive scenarios, product complexities, and involvement of multiple stakeholders from both buyer and seller sides makes price dealing and negotiations extremely tricky propositions.

Vendors across markets and industries, generally try to offer a value to their customers that are aligned to customer processes, adaptable to changing scenarios, and directly affecting the business outcomes of the customer. Customers too on the other hand, are negotiating deals and renegotiating old contracts and licenses to demand benefits that are more than just cost arbitrage, volume-channel discounts or outsourcing engagement gains. Customers generally would like to pay for results and only for the exact part of the value pie, they utilize. Upon finalizing the deal and with subsequently gained maturity, markets become transparent such that each party involved in the deal gains clarity on margins and benefits realised out of the dealt services and products. The providers of products and services, due to an inherent ambiguity involved in pricing the deal in compliance with time, space and value, have typically no headroom to drive profitability.

Moreover, engagements of information technology (IT), worldwide has become increasingly complex, vendors are trying to differentiate themselves by offering robust information technology service and deployment architectures involving an integrated mix of configurable software components and toolsets. Further, the vendors are customizing their offerings suitable to each specific engagement, expert consulting and maintenance services bundled around the core offerings. Simultaneously, information technology customers are increasingly negotiating for service level agreements (SLA) based deliveries, value based IT spend and embedded domain expertise with their vendors. Thus, quantified and context-driven business benefits thus have become a greater input to IT products and services pricing than standard rates and generic list prices.

In such a scenario, high competitive pressures entice sales managers, to realize the sale, adopt the typical strategy of dropping the sale price of their offering to lower extent that may not be as profitable as expected. Though customer acquisition and retention is paramount, sales managers and business heads are failing to realize the non-sustainability of such strategies for their product and companies in the long term. This pattern has being replicated over years, which has led to a downward spiral on margins, average industry Return on Investment (ROI) and quality of deliverables.

Hitherto, many pricing strategy models have been employed to cover the ever-changing business scenarios and conditions explained above. One of the established pricing methods includes time and material pricing or fixed value pricing that has been transformed into few newer frameworks, viz. a outcome based pricing, a transaction oriented pricing, a psychological pricing and a referential pricing which provide newer ways of quantifying price and capturing value provided to a customer.

A typical utility pricing model disclosed in US 2008/0097932 issued to Dyck et al., teaches a method for determining a price level for a computer-based service utility comprising a mathematical estimation of consumption/usage based prices based on low-high limits of usage, historical numbers, consumption schedules, and discount models.

Similarly, market factors based pricing models disclosed in U.S. Pat. No. 7,853,473 issued to Davis et al., discloses rules and constraints based on competitor prices, brand equity and sales volume.

U.S. Pat. No. 7,379,922 issued to Pericle teaches a sales oriented pricing model. Pericle further teaches that a price of commodity products is based on historical databases of price, customer sale preferences and market variance.

In usage based price determination, a pricing system modelled on pay per use by Circenis et al. is disclosed in U.S. Pat. No. 7,571,143, the Circenis et al. teaches a metering and data collection to monitor usage and transactions and calculate price.

Amongst such variety of approaches and pricing techniques, there still exist a number of challenges that are limiting the efficiencies of the existing pricing models and applicability across different scenarios. One of the prime limitations in the existing pricing models is the lack of applicability for varied contexts of an engagement/deal. These models are generally based on many assumptions and pre-conditions for applicability. To illustrate, let us take the case of an IT Service Pricing methods. The IT Service Pricing methods like effort based or time & material based pricing cannot be transposed over calculating the price of an IT Product. This is because, a Business Owner may not have an extensive visibility of a customer environment and requirements compared to an IT Service Manager.

Similarly, in a commodity industry which is based or a business-to-consumer pricing paradigm (example, FMCG goods), a single pricing model may also not be applicable uniformly for every business and varies significantly from business-to-business and products/services. Thus, if the choice of strategy is ad-hoc, or historically biased, there is greater probability that both the Sales Manager and the customer would misunderstand explicit or implicit benefits of these models. Accordingly, due to incorrect understanding, improper data is generated and an undesirable context may be captured leading to an ill-informed decision, non-optimum price and even a failed deal.

Another limitation with the existing methods is that they are confined to capture information related to either sales activities (Sales Targets, Discounts and Revenue) or engineering (development and feature based) activities or business feasibility (Investments and Profitability), or delivery specific pricing (Units ordered, utilization of resource based) etc. Using any one of the input sets, the existing methods optimize a price determination. However, there is no mechanism present that can combine all these input factors to generate consolidated optimum deal price.

Yet another limitation of the existing methods is that each of these existing methods comes with its set of assumptions and variables. However, organizational objectives, historical data, competitive analysis, customer environment conditions as well as the fitment of the solution are not captured for each individual engagement.

Therefore, in a deal, for realizing justifiable profits while being competitive, there is a need for a framework to exhaustively capture and process the deal related information, a context of the deal, and various perspectives associated with the deal including but not limited to an organizational objectives, historical data, competitive analysis, customer environment conditions and fitment of the offered solution. Adjunctively, in any dynamic business environment, it is desirable to have a responsive architecture that can consolidate deal information with various dynamically varying factors and juxtapose each deal scenario affected due to those factors to figure out a justifiable optimum deal price.

Moreover, while arriving at a justifiably informed decision with the help of computationally intensive analytical assistance system, such computing system is further desired to be holistic in intelligence gathering and reliable in offering solution to various dynamic situations related to time, space and value.

### OBJECTS OF THE INVENTION

The principal object of the present invention is to provide a system that enables the calculation of a list price of a product/service and/or a deal specific price of the same.

Another object of the invention is to provide a system for exhaustively capturing an appropriate data and context so that data captured is applicable to various existing methods of pricing to make a well-informed decision.

Yet another object of the invention is to provide a system that enables capture of multi-stakeholder information and customized views of pricing related inputs, analytical insights and scenarios based assessments for each stakeholder to assist them in decision-making.

Yet another object of the invention is to capture organizational objectives, historical data, competitive analysis, customer environment conditions, as well as the fitment of a solution for each individual engagement.

### SUMMARY OF THE INVENTION

Before the present methods and apparatuses are described, it is to be understood that this invention is not limited to the particular apparatus and methodologies described, as there can be multiple possible embodiments of the present invention, which are not expressly illustrated, in the present disclosure. It is also to be understood that the terminology used in the description is for the purpose of describing the particular versions or embodiments only, and is not intended to limit the scope of the present invention, which will be limited only by the appended claims.

Although setting a price for a particular product/service is not a new phenomenon, the ability to identify the best fit method for price calculation and dynamically synchronizing the objectives and constraints of multiple stakeholders has been absent so far in the field of pricing. The addition of these two capabilities will enable a win-win situation for both the vendor and the customer. Taking an analogy of management of information in an organization, this field was revolutionized by the introduction of Enterprise Resource Planning (ERP) systems. An ERP system when deployed, allowed various departments of an organization viz. finance, manufacturing, sales, human resources etc. to effectively share and utilize cross-functional information which was not possible before. This provided the organization managers a more complete and accurate perspective thereby aiding decision making, optimizing resources, mitigating risks, and eventually driving better efficiency and profitability.

The present invention deals with a system for computing a price/credible deal price to be charged for a deal. The deal would typically involve a plurality of stakeholders. The system comprises of a presentation layer module adapted to capture and display a first data set during initialization of the deal under deliberation and a second data set from at least one stakeholder. The presentation layer module captures information, which is used by various data processing modules of the system and displays the processed information. A preliminary information processing module is configured to process information from at least one stakeholder relating cost & investment projections, market analysis & competitive benchmarking, revenue forecast & business planning, and deployment & engineering options. A pricing strategy module processes the one or more inputs of second data set from the at least one stakeholder to determine at least one preferred pricing model to be used or mapped based on a context derived by juxtaposing the first data set with the second data set.

A pricing strategy consists of a set of decisions proposed in deriving a most optimum process for calculating the deal price of the offering. The pricing strategy module uses a pricing model selected to calculate the optimum list or deal price, guidelines of negotiating with the customer whether benefits oriented or features oriented, or outcomes oriented, of selecting the right delivery options, and internally achieving a collaborative approval from all stakeholders with respect to their objectives and constraints.

The pricing strategy module further executes one or more pricing models to calculate a list price indicator. A pricing model is defined as a method and a set of rules for deriving the deal price of a product or offering. It involves a set of qualitative and quantitative inputs, establishing a key lever (e.g. Cost to Produce for a Cost based model, or Customer Savings Planned in case of a Value Based Model), and a logic based approach to calculate a premium or a benefit share as a part of the price. Pricing Models comprise of iterative workflows, metrics such as, assessment metrics, scenario metrics, sales metrics, negotiation parameters and preferred output price indicator indices over and above the main the set of rules.

The list price generator module then uses this list price indicator. The list price generator arrives at the list price by providing views to the one or more stakeholders to collaborate and agree on a value. This list price is then used by deal negotiation module to optimize the price for a specific deal and specific customer expectations and internal objectives.

The deal negotiation module is further adapted to capture a customer perception, which is unlike other inputs is an abstract and subjective quantity, for at least one factor selected from a group comprising a brand perception, a competitive positioning or an alignment of the service/product with the customers system or environment. Accordingly, the system of the present invention is adapted to take into consideration clients' perception as a quantifiable input. The multiple scenarios around variables dynamic to the pricing environment are simulated by the scenario generator and are provided to multiple stakeholders. A third data set is configured to capture historical information associated with the deal and thereof and comprises of the dynamic variables, wherein the dynamic variable are associated with time, scope and value realization pertaining to the deal. Accordingly, the third data set enables a scenario generator to create multiple scenarios based on the dynamic association with time, scope and value realized which then is provided to the plurality of stakeholder according to the attributes thereof.

The system of present invention facilitates system level data integration of the first data set, second data set, the third data set and the clients' perception mentioned above.

### BRIEF DESCRIPTION OF DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific methods and product disclosed in the drawings:

FIG. 1, Illustrates an exemplary network environment implementing a dynamic multi-dimensional and multi view pricing system, in accordance with an implementation of the present invention.

FIG. 2, Provides details of the dynamic multi-dimensional and multi view pricing system, in accordance with an embodiment of the present invention.

FIG. 3, Illustrates a sample result from execution of the selecting pricing strategy sub module part of the selecting and executing pricing strategy module for an embodiment of the present invention

FIG. 4, Illustrates a sample graphical result from the risk assessment sub module part of the scenario generator module for an embodiment of the present invention

FIG. 5, Illustrates a sample graphical result for the Engineering View of the list price generator module for an embodiment of the present invention.

FIG. 6, Illustrates an exemplary flowchart for implementing dynamic multi-dimensional and multi view pricing in an organization, according to an embodiment of the present subject matter.

FIG. 7, sample graphical representation of engineering features of EDM.

FIG. 8, illustrates effect of risk combinations.

FIG. 9, illustrates revenue realization context for the Deployment Manager

FIG. 10, illustrates a sales view.

### DETAILED DESCRIPTION

Some embodiments of this invention, illustrating its features, will now be discussed:

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems, methods, apparatuses, and devices similar or equivalent to those described herein can be used in the practice or testing of embodiments of the present invention, the preferred, systems and parts are now described.

The disclosed embodiments are merely exemplary of the invention, which may be embodied in various forms.

### DEFINITIONS OF THE TERMS

The terms “database,” or “repository” refers to a common term “repository” and essentially mean the same.

The terms “first database,” “first data set”, or “primary information,” refers to common term “primary information” associated with a project initiation and essentially mean the same.

The terms “second database,” “second data set”, “stakeholder input,” or “stakeholder feedback” refers to a common term “stakeholder input” and essentially mean the same.

The terms “Business head,” “Business owner,” “business leadership,” or “business manager” refers to a common term “business manager” and essentially mean the same.

The terms “engineering head,” “product engineering head,” or “engineering manager” refers to a common term “engineering manager” and essentially mean the same.

The terms “delivery head,” or “delivery manager” refers to a common term “delivery manager” and essentially mean the same.

The terms “sales head,” “deal negotiator” or “sales manager” refers to a common term “sales manager” and essentially mean the same.

The terms “product,” “service,” “product/service,” “offering,” or “solution” essentially refers to the entity being priced.

In a preferred embodiments of the present invention, a dynamic multi dimensional and multi view pricing model hereafter referred to as DMMPM provides a computing framework for scientific pricing, to tackle the challenges faced by existing pricing methods. The DMMPM system of the present application establishes a system architecture and a process for an integrated pricing of products, services as well as combinations of both in various transactional scenarios and industries. Transactional scenarios are those scenarios created by the scenario generator module during deal negotiations. Based upon acquired cognitive intelligence, these scenarios map the variability of the customer environment and the offering's deployability with respect to some parameters in multiple discrete sets. Transactional scenarios are used by the Deal Manager to evaluate the best fit recommendation in each iteration of negotiations.

The DMMPM system offers a realization of various pricing models, both novel and prevalent and proposes the right scenarios and conditions to use them. The DMMPM system is further adapted to be used by various stakeholders including business owners, sales heads, engineering manager and delivery managers for arriving at a reasoned pricing of a product or service to facilitate a decision regarding a deal under deliberation.

While determining such a reasoned price for the product or service, the DMMPM system is configured to take into account an ideation to market costs, effects of competition, customer's perception of value, internal organizational factors and other important parameters. The DMMPM system also enables stakeholders to view and evaluate various key pricing levers while inputting respective inputs into the system. For example, the pricing model helps stakeholder decide the right deployment options for the customer, the right discount ranges they can use or the optimum combination of engineering features they should take to market. The DMMPM system justifies their price, offering and business case, rather than forcing them to succumb to market pressures or targets through making ad-hoc and symptomatic decisions.

The DMMPM system of the present application is aimed at arriving at the right price to ensure optimum profitability while winning deals to maintain targeted market share. This right price presents a win-win situation for both customer and provider. The DMMPM when used by a deal negotiator would help him ensure that his price mirrors the value derived by the clients and also does not leave lot of his company's money on the table.

For the purpose of gaining an understanding into the underlying principles of the invention and its various features, references will be made to the embodiments illustrated in the drawings. Also, it is important to note that the detailed description presented herein does not intend to dilute or limit the scope of the invention. Any alterations and further modifications in the described embodiments and any further application of the principles of the invention as described herein are construed, as it would normally occur to one skilled in the art to which the invention relates. This model can be applied across all industry sectors with both products and services as output. The examples from Information Technology industry have been used for the purpose of illustration and better understating of the model.

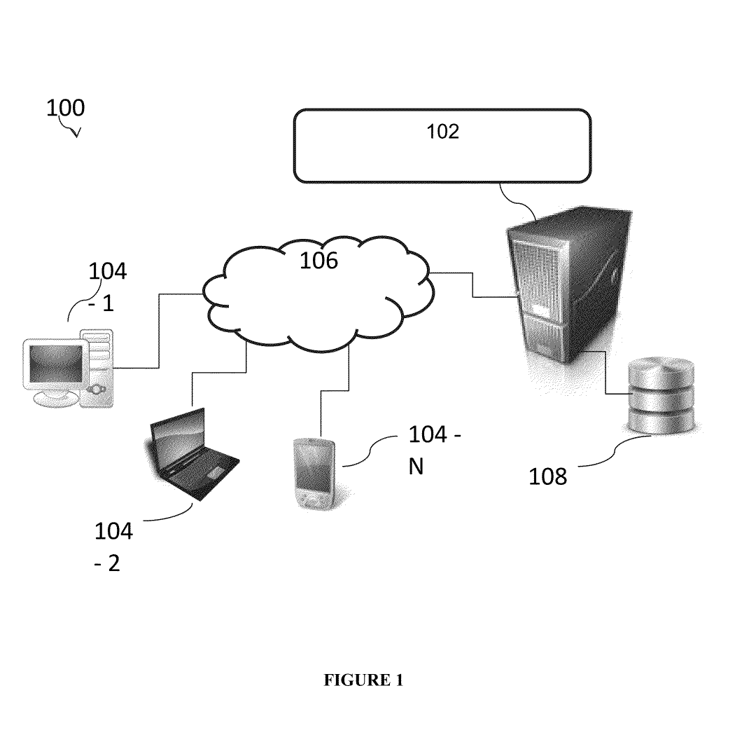

FIG. 1 represents an exemplary reliable computing system (100) implementing dynamic multi dimensional and multi view pricing model system for providing an integrated process for pricing products, services and combinations of both, according to one of the embodiments of the present disclosures. In an embodiment, the reliable computing system (100) comprises a plurality of communication devices (104-1, 104-2 . . . 104-n), collectively referred by (104). According to one embodiment, at least one stakeholder (not shown in the figure) can access a DMMPM application hosted on a server (102), through a plurality of communication devices (104). The DMMPM application and the server are referred by (102), as the server hosts the application. The plurality of communication devices (104), interact with the server (102) over a communication network (106). The server (102) is connected with a repository (108) to store information processed by the server (102). The repository (108) can be implemented as a database or a file system hosted on an external server or can be embedded or residing inside the server (102). The plurality of communication devices (104) may be implemented in a variety of conventional computing devices, including but not restricted to devices such as a desktop, notebook or portable computer, tablet computer, a mainframe computer, a mobile computing device, an entertainment device, a computing platform, an internet appliance, servers and similar systems. The said communication network (106) can be selected from the internet, intranet, and any other communication networks. In a preferred embodiment, the communication network (106) is internet.

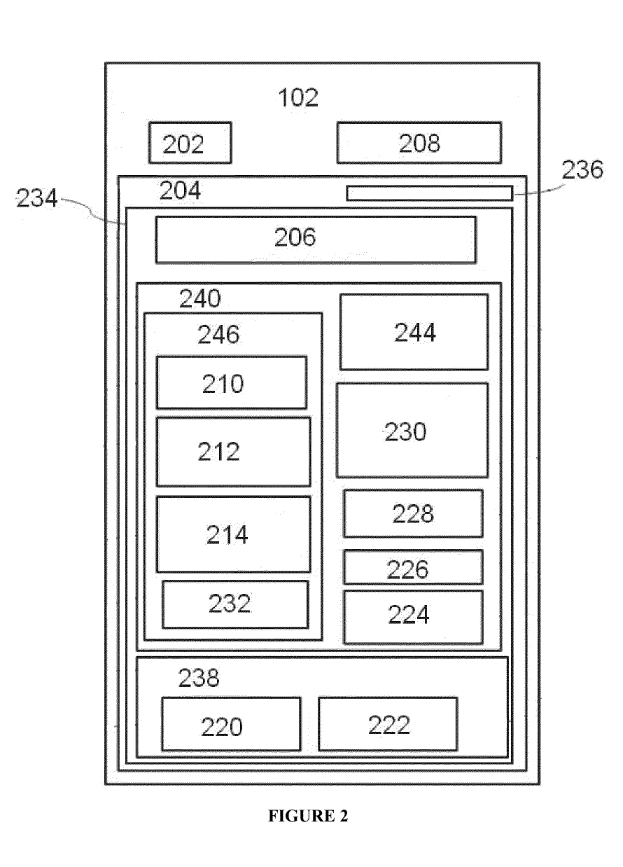

FIG. 2 provides a conceptual representation of the components of a dynamic multi-dimensional and multi view pricing model (DMMPM), in accordance with an embodiment of the present invention. In the said embodiment, the DMMPM system (102) includes one or more processors (202), supporting circuits (208) and a memory (204) coupled to the processor (202). The processor (202) may be implemented as one or more microprocessors, microcomputers, microcontrollers, digital signal processors, central processing units, state machines, logic circuitries, and/or any devices that manipulate signals based on operational instructions. Among other capabilities, the processor (202) is configured to fetch and execute instructions and data stored in the memory (204). The supporting circuits (208), includes components, for example, but not limited to, Input/output (I/O) interfaces (not shown in the figure) and network interfaces (not shown in the figure).

The network interfaces enables the DMMPM system (102) to communicate with other computing devices and peripheral devices, such as web servers, and external databases over the network (106, Not Shown here). The network interfaces may facilitate multiple communications within a wide variety of protocols and networks, such as wired networks, e.g., LAN, cable, etc., and/or wireless networks, e.g., WLAN, cellular, satellite, etc.

In a preferred embodiment, the memory (204) includes program modules (234) and program data (236). The program modules (234) include routines, programs, objects, components, and data structures, which perform particular tasks or implement particular abstract data types. The program modules (234) further include a presentation layer (206), a business logic layer (240), and supporting modules (238). The supporting modules (238) include database connector (220), and an admin module (222). The database connector (220) provides a connection to the database (108) (Not Shown here). This connection is used by other modules to read, write, modify or delete data in the database. The other modules may include programs or coded instructions that supplement applications and functions on the DMMPM system (102).

The Admin module (222) maintains the list of users authorized to access the system and also provides mechanisms for authentication to access other modules of the system. The admin module (222) maintains a mapping between users and roles and also the mapping between roles and data fields accessible to each role under read or write permissions. The mappings can be modified using a predefined admin access. In one of the embodiments the roles are: Business manager, Sales manager, Delivery manager and Engineering manager. As the name suggests the Business manager is the supervisor for the other roles i.e. Sales manager, Delivery manager and Engineering manager and is responsible for the profits generated from the product. The Business manager reports to senior management of the company or other roles as per company norms. The Sales manager is responsible for offering sales. Delivery manager is responsible for Operations and Delivery of the offering to the customer. The Engineering manager is responsible for designing, developing and enhancing the product, service or combination. In another embodiment, the roles can be clubbed or more roles can be present. The Business manager has access to create a project for pricing a particular offering and add the users to the project.

A Presentation layer (206), provides a mechanism for the users' to access various modules of the DMMPM system (102) like Cost Aggregation & Investment Planning (210), Revenue Forecast & Business Planning (232), Market Analysis & Competitive Benchmarking (212), Pricing Engine (226), Deal Negotiation (228) and Admin (222) through communication devices (104) (Not shown here). In the preferred embodiment, the Presentation Layer (206) provides an access to the various system modules through a unified portal. Each of the system module has at least one screen to provide inputs, view reports and dashboards. The access to inputs, reports and dashboards is controlled through mappings in Admin module. In an embodiment, the admin module has a screen to provide credentials for login into the system. In another embodiment, the admin module also has a screen to define and modify mappings. In yet another embodiment, the admin module has a screen to add and delete users. The presentation layer (206) contains the logic for Personalization, Common Visualization and Integrated Reporting.

The Business Logic (240) Layer comprises of five major sections: a Preliminary Information (246), a Selecting and Executing Pricing Strategy (230), a List Price Generator (224), a Scenario Generator (244), a Pricing Engine (226) and a Deal Negotiation (228). The Preliminary Information module (246) captures the information related to initiating the pricing of an offering through the Presentation layer (206). The Preliminary Information module (246) comprises of various modules including but not limited to Cost Aggregation and Investments Planning (210), Market Analysis and Competitive Benchmarking (212), Evaluation of Deployment and Engineering Options (214) and Revenue Forecast and Business Planning (232).

In one of the embodiment, all the four stakeholders have read access to all modules. Sales manager has access to write or modify Deal Negotiation module (228), Market Analysis and Competitive Benchmarking (212) and Selecting and Executing Pricing Strategy (230). The Delivery manager has access modify to Evaluation of Deployment and Engineering Options (214) and Deal Negotiation module (228). The Engineering manager has modify access to the Cost Aggregation and Investment Planning (210) and Evaluation of Deployment and Engineering Options (214). The Business manager has modify access to the Revenue Forecast and Business Planning (232), Selecting and Executing Pricing Strategy (230) and Deal Negotiation (228). List Price Generator (224) and Scenario Generator (244) would be accessible to all stakeholders.

Price/Pricing Engine (226) module enables the workflow to drive the entire pricing process across different roles. The Price/Pricing Engine (226) keeps track of the progress on a particular pricing deal. It also saves the data entered by various users to the database (108) (Not shown here) and fetches them for reports, dashboards, and re-entry to the screen. When a particular user logs into the system (102), the Price/Pricing Engine (226) checks with Admin (222) to display the modules which particular user can access and progress further on that particular project. A user can go to Cost Aggregation & Investment Planning (210), Revenue Forecast & Business Planning (232), Market Analysis & Competitive Benchmarking (212), pricing engine (226), Deal Negotiation (228) depending on access provided by the Business manager.

Cost Aggregation and Investment planning (210) component takes the cost related parameters from the presentation layer (206) and performs predefined mathematical operations on them. In one of the embodiments, the system provides various categories to classify existing and future expenditures. To help in better predictions the module allows the cost to be bucketed into an Investment and Operational expenses. It also captures the typical cost incurred for delivery of each project. To help in estimation of these costs, the module also provides various sub groups like raw materials cost, man power costs, which can be fixed or varying depending on the context.

Revenue Forecast & Business Planning (232) component takes sales volume related parameters from the presentation layer (206) and performs a set of pre defined mathematical calculations on them. In one of the embodiments, the Revenue Forecast & Business Planning (232) module receives the past sales of the offering and factors to project future sales including market plans with respect to current segments, geographies, sales efforts projected, sale competitiveness and external factors effecting demand. Based on these factors, the module projects future sales of the offering in a particular time frame. It also creates scenarios for the sales year on year for the timeframe.

Market Analysis & Competitive Benchmarking (212) component takes the data on relative positioning of the offering with respect to competitors. This analysis is done using parameters including but not limited to technological strength, functionality, market share, customer relationships and intellectual property. These factors can be segregated into the strength of capabilities provided by the product/service and the maturity of the underlying technology w.r.t. an overall technology lifecycle. Based on this data, the Market Analysis & Competitive Benchmarking component (212) calculates a composite index representing the market dynamics and competitive positioning of the product/service.

Selecting and Executing Pricing Strategy (230) module comprises of two sub modules Selecting Pricing Strategy and Executing Pricing Strategy. The Selecting Pricing strategy sub module maintains a pricing strategy selection mechanism that evaluates the applicability of each of the pricing techniques w.r.t. the present business context and proposes a best fit. This module has a list of criteria that helps quantify the uniqueness of offering, its maturity in the market and it's alignment to customer requirements or scope of the deal/transaction. Each criterion is self-rated by the user (typically on a scale of 1 to 5). The rating given is then weighted/compared for each pricing model and the pricing technique that has maximum percentage of applicability is recommended as the best fit.

For example, an offering has a host of functional and non-functional features that are distinctly superior to competition in a multi-player market and are specifically needed by the customer, a features oriented model might be appropriate. Another system that helps in drastically reducing human effort and increasing efficiency in a Business Process Outsourcing (BPO) environment might opt for a Customer Value based model to calculate its price. A standalone, niche venture purely customized for a particular customer might opt for a Cost margins approach or an Outcome oriented strategy.

The Executing Pricing strategy sub module entails various pricing strategies to enable its users to arrive at a price indicator. These strategies perform the critical job of evaluating what should be the right premium to charge the customer. In one of the embodiment four different kinds of strategies viz. Cost Based, Market Based or Customer Savings based or Outcome based strategies have been used. It strategy to be used for calculating the price indicator is provided by the Selecting Pricing Strategy sub module based on the applicability of each of pricing strategy w.r.t. a business context and proposes the best fit.

In one of the embodiment, a Cost Based strategy is used to calculate the price indicator. The Cost Based strategy is widely used model of pricing, it estimates the total investments of the organization in building and productizing the offering and taking it to the market. The research, developmental, operational, support and delivery costs are all aggregated. The model then calculates the relative strength of its offering by weighing distinct product capabilities of the offering alongside the solution's alignment to the customer's requirements. Additional parameters around solution's features and brand strength, customer's relationship, and competitive landscape are also factored in. The factored weightage for each of these criteria is averaged used to calculate the mark-up of the offering to be added to the overall unit price.

In one of the embodiment, Market based strategy is used as yet another strategy to calculate the price indicator. Market Based strategy for pricing analyses unique features of the offering to be priced and monetizes its value w.r.t. the customer requirements. Market Based pricing first identifies the broad features and functionalities that are important to the customer/prevalent in the market.

It then weighs each of these features based on the following:
Customer need of the particular feature (whether a desired feature is “a must have feature” or “critically dependant on” or “a nice to have but not necessary feature”),
Feature complexity and difficulty of implementing, integrating and deploying the solution,
Comparison of both the offering and its alternates (competition), w.r.t. alignment to the customer requirements or scope of the deal/transaction and quality of features

While employing the Market based strategy and upon assigning weight to various features, comparative indexes are factored to arrive at a price.

In one of the embodiment, a Value Based strategy is used as yet another strategy to calculate the price indicator. The Value Based strategy calculates the potential benefits the buyer may gain by using the offering in its environment. An optimum percentage of the overall benefits are then considered as a price of the offering. The model classifies a type of savings into key categories and uses corresponding sub-models to quantify the benefits. Some of the categories include Automation of Manual Processes, Faster Time to market/Increased Revenue Possibilities, Integration & Impact Management, Reduction of Operating Costs and Assets, Leveraging of Domain experience and System Learning, and Risk reduction and Compliance systems

In one of the embodiment, an Outcome Based strategy is used as yet another strategy to calculate the price indicator. The Outcome based Pricing technique calculates the price based on the benefits derived from a business outcome generated out of the offering. Pricing an offering around outcomes follows the philosophy of paying for success towards a desired result instead of paying for individual items. A clear understanding of the scope of work and outcomes, transparency in trust and relationship with the customer is required to run such a model. The model proposes an Investment proportion scenario, a Risk Analysis and criterions for success/revenue generation to calculate a portion of the realized benefits as the list price.

The Outcome based pricing strategy works for
Metered Usage or Transaction oriented engagement models.
SLA based business outcomes and pricing.
The Benefits, Risks and Investments sharing model with a partner or another key organization in the customer's value chain

Evaluation of Engineering and Deployment Options (214) component takes in data on the delivery options (User or Server Licensed, Usage based, technology transfer, SLA and outcomes based), and the developmental options whether standalone developed or a reusable asset. The calculations in this component result in a set of indices, which indicates the relative price indicators for various product/service delivery options. The Evaluation of Engineering and Deployment Options (214) provides different modes for licensing and deployment of the offering. In one of the embodiments the engagement options supported by the module are:

Licensed Engagements: This kind of engagement involves a variety of agreements to sell the product perpetually to the customer. The main license options are Per User Licenses, Enterprise Wide licenses, CPU based licenses (Per Server or Per Processor). Licensed products are generally deployed on premise of the customer. The payment involves a onetime license fee and annual maintenance contracts for support and upgrades. The model provides key inputs around options for deploying various on-premises floating, node-locked, subscription oriented and perpetual licenses with scenarios and guidelines around the applicability of a particular type for each scenario.

Subscription Engagements: These kinds of engagements involve agreement to lease out the offering for a particular time period to the customer. This also has variations in terms of per user or enterprise wide usage. In case of subscription product is hosted by the service provider (or over a cloud) and generally, multiple clients are served from the same installed base. The payment is in form of subscription charges for a particular time period after which they need to be renewed to continue the use of product. The subscription charge takes care of the core product, support and upgrades.

Provisioning Engagements—These are consumption or transaction oriented engagements where the consumer purchases a defined quantity of a service or resource. Some IT industry examples include, Cloud based (hosted Services) deployments, on demand transactional services, software as a service processing KLOC s of code or Database records etc. This engagement varies from the typical Subscription engagements as the service is not defined in terms of number of users.

The List Price Generator (224) module identifies and supports stakeholders involved in a complete pricing process. In one of the embodiment, there are four stakeholders Business manager, Sales manager, Engineering manager and Delivery manager, which are mapped to roles in the Admin (222) module. Each of these stakeholders has critical information to input while calculating a right list price or a deal price of an offering. At the same time, their scrutiny on the dynamic (changing) environmental factors of an offering is also necessary so as to ensure that price is optimally aligned with the individual objectives and constraints of all the stakeholders. The Pricing Model provides a mechanism to synchronize all these parameters to help achieve an optimum pricing decision. The DMMPM system (102) also provides key metrics dashboards relevant to these stakeholders. It may be understood that metrics are objective, reproducible, and quantifiable measurements that are calculated based on one or more data, an inherent logic and providing an output that can be used for further analysis and decisions.

In the current subject matter, each stakeholder has an integrated dashboard and a scenario generator. The scenario generator (244) gives the ability to each of these stakeholders to generate different scenarios for one or more key parameters and upon evaluation, elucidate its sensitivity to price.

A Business Manager's view enables him to view to overall Business Plan of the offering. The Pricing model enables for him a key set of outputs and analytical information essential for making business decisions. The Business Manager is given the overall profitability trends, Return on Investment data and an overall aggregation of Costs. He is enabled to input Profitability levers (e.g. minimum markup), billing rates, breakeven targets etc. into the system. The model allows the Business Manager to generate scenarios for projected sales and average price charged and optimize it for profitability. It also allows the Business Manager to visualize a recommendation of the optimal product/service offering based on the analysis of product positioning, best fit market segments and geographies and market conditions. The best fit scenario selected by the business owner serves as the input for other three views.

A Sales Manager's view includes inputs like sales target, list price and discounting and margin levers to operate. This view enables him to create scenarios for distributing the sales target across multiple geographies and channels based on the historical sales and discounting information available, sales force distribution, sales force effectiveness, forecasted demand potential and planned promotions.

A Delivery Manager's view enables him to generate various scenarios around optimum distribution of available support and implementation resources required for delivering an offering to the customer environment. The Delivery Managers' view includes an aggregation of various overheads and project expenses accrued. The delivery manager can also view the Deal Specific inputs (Timelines for delivery, type and quantity of deployed licensee, deployment environment, services to be provisioned or transport, training and consulting requirements). The DMMPM system (102) calculates the probability of meeting the expected delivery SLA's depending on the complexities involved and the delivery timelines.

An Engineering Manager View takes into account a benchmarking and competitive referencing parameters vis-à-vis the offering to create right combination (bundle) of components such that a value proposition of the offering is met in terms for the target segment. It also ensures that the resultant price calculated is not very sensitive to changes effected by various product bundling, features configuration and other engineering scenarios applicable across various engagements. Some of the major parameters included in the engineering view are Product Features Benchmarking, Definition of multiple Product Bundles, Engineering cost analysis, and Market Segment mapping with Product Features.

An integration module combines all the above views into an integrated pricing context. Even though all the stakeholders to the pricing process have inputted their own abstracted views into the system, the dynamic multi-view model ensures that dependent information is cascaded from one view to the other through variable with appropriate checks and alerts. Variables may be calculated by combining and validating more than one parameters from different stakeholders in a logical algorithm. Since variables present information understandable and utilizable for the present stakeholder, they reduce chances of mis-interpretation or erroneous calculations.

The integration module also maintains a set of checklists and rules to help each role of the stakeholder to gather information as well as generate and evaluate multiple scenarios. E.g. the system provides warnings if the sales scenario selected by the sales manager does not meet the breakeven targets and profitability limit set by the Business Manager.

The Multi-View Model ensures the sanctity of the data by correlating in the following ways
Sharing Sales Projections, Targets and Revenue Forecasts between Sales, Engineering and Business Manager
Taking inputs of Engineering, Sales and Business Manager in Product Benchmarking as well as Solution Fitment
Synchronizing Deal Specific data between the Sales and the Delivery Manager
Feedback of Historical Information regarding Costs, Sales realized, Requirements fitment, Deal Competitiveness to all views.

The Scenario Generator (244) is a module, which is used by other modules of the pricing model including Selecting and Executing Pricing Strategy module (230), Deal Negotiation (228), List price Generator module (224) to assess the dynamic variability of the offering in the market environment. A user can explicitly address his assumptions and uncertainties by means of defining multiple scenarios for a particular external/internal factor and view its effects on the price of his offering. Once the inputs are entered based on the best available information, one can use the model to periodically iterate and simulate what-if conditions, see responses to external changes and aid overall decision making.

The Scenario Generator (244) module exposes scenarios pertinent to both market and engineering factors with the aim to optimize for value generation and profitability. The key dynamic levers are Risk, Sales Volume, Profitability, Product Feature bundling and Market Competitiveness.

The Scenario Generator (244) module provides various scenarios to aid in assessing risk options during deploying a solution. Additionally, risk evaluations during joint-investment and partnership forays or while Service Level or Outcome based Contractual Agreements are also dynamically done. These scenarios first identify and categorize two or more major risk inducing factors for the successful deployment of the offering. Using a combination of these factors, various scenarios governing probability (partial or complete realization of the risk) and vulnerability (impact w.r.t costs and schedule, loss of opportunity, penalties and risk mitigation overheads) are used to determine the overall Risk Premium.

The premium is combined with the potential benefits, competitive capabilities and total investment to arrive at the price point. Using all these scenarios, the user can choose the right combination of the critical variable set (as defined before) to optimize for profitability and derive the right price.

The Business manager of the offering can evaluate multiple scenarios around sales numbers realized for his product through the model. For each scenario, he is provided with the corresponding profitability, and associated costs. This helps him in analyzing the right Sales strategy (targets, timelines and discount levers) to affect the most optimum profitability numbers. The actual sales figures are also fed back into the system to capture historicity and dynamically update the revenue forecasts.

The DMMPM system (102) enables the engineering owner of the offering to ideate on various engineering and development oriented options to take to the market. The Engineering manager can evaluate the right combination of components across different component-bundling scenarios and view the resultant price. He can also analyze the cost of engineering, deployment and maintenance of a particular product, solution or service.

A product, solution or offering needs detailed benchmarking w.r.t. its immediate competition/alternatives in a deal to assess its own competitive strengths and appropriately price itself for its customers.

The Dynamic Multi-Dimensional Multi-View model (102) allows a user to list all the major functional and non-functional components of the solution. It then identifies the main competitors, and their corresponding products in question.

Periodically one can assess the relative strengths and weaknesses of a solution by
Rating each component capability as Market Leading, Differentiated, Standard, Basic etc.
Assess the value of each sub-component in a product.
Calculate the relative weighted strength of the solution

The Deal Negotiation module (228) helps input various deal and negotiation specific details to arrive at an optimum deal price or credible deal price. It runs through the complete pricing process from model evaluation, mapping the customer's environment into inputs and evaluating the various deployment options. The right discount or premium over the list price/credible deal price is calculated based on the license type, deal volumes and channel or strategic focus. A negotiated deal price is achieved at the closure of a deal. It comprises of the agreed deployment options around the product and service or a combination thereof, the agreed pricing values. The negotiated deal price also incorporates transactional charges and the financial options including payment schedules, interest, overhead and taxes as a part of its deal management features.

The Deal Price of an offering may vary greatly to its list price. To illustrate, if there is a high customer need for exactly those features that the offering is the best in class in, the deal price point should command a higher premium. At the same time, a higher discount should get reflected for a scenario where the offering possible faces a commoditized evaluation from the customer with multiple other competitors and alternative solutions in contention.

The Deal Negotiation module (228) also enables two levels of discounting for its user in one of the embodiments. The first level is volume discounting model. Depending on applicable license type of the offering (e.g. User license, Enterprise license, Server license, and thereof), there are different discount slabs which depends on volume of licenses purchased by customer. The Volume discount increases with increase in purchase of licenses of the offering, which has been optimized with the delivery costs involved, and current demand trends.

Provision for second level of discounting is based on various levels of negotiation (e.g. Channel Discounts, Strategic Discounts). These can be exploited by various key stakeholders (e.g. Sales Manager, Business manager and thereof) to create bigger opportunities in future.

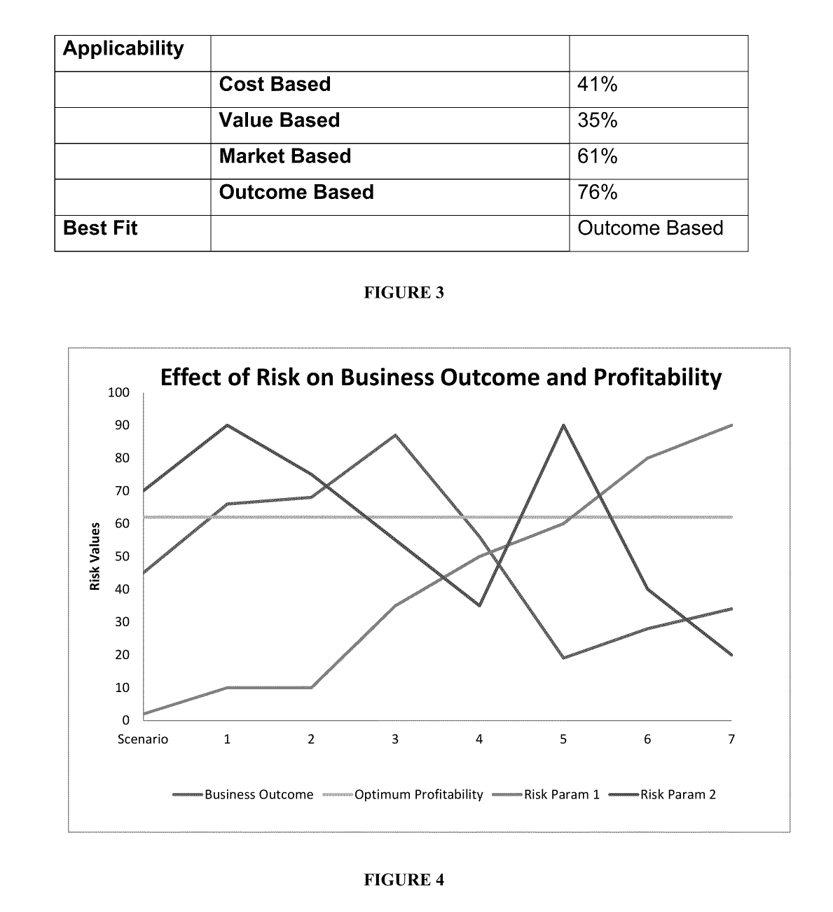

The FIG. 3 illustrates the sample results from selecting and executing pricing model in one of the embodiments. The figure shows the various percentages of applicability of the four pricing strategy models available and recommends one of the models to be used for price indicator calculation. A FIG. 4 illustrates a sample graphical result from the risk assessment sub module part of the Scenario generator module for an embodiment of the present invention. The chart in the figure plots various risk parameters considered, optimum profitability and business outcomes for various scenarios generated by the Scenario generator for the Business Owner View. This will provide a perspective for the business owner to select a particular scenario.

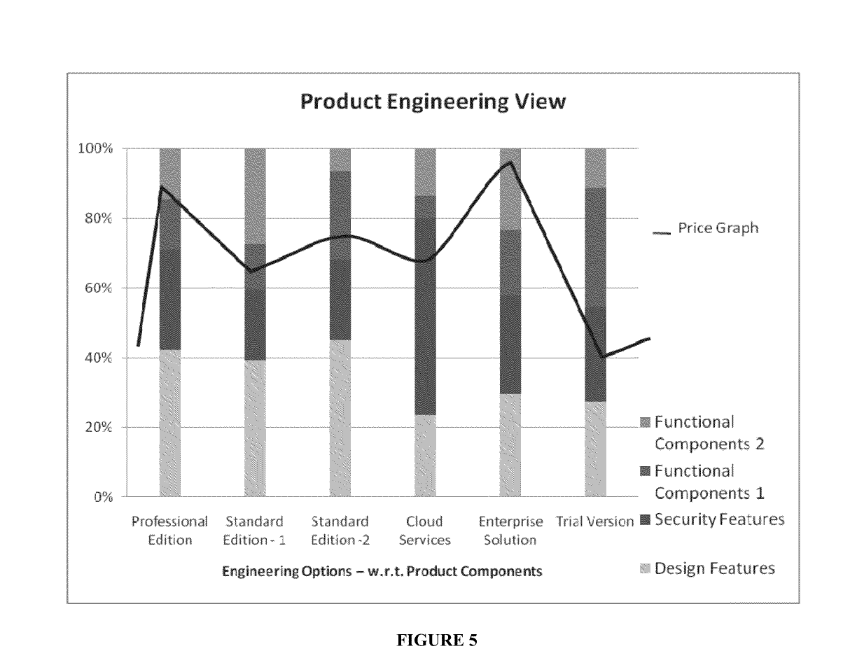

A FIG. 5, illustrates a sample graphical result for the Engineering View of the list price generator module for an embodiment of the present invention. This view helps the engineering head get a graphical view of functional breakup of the various product editions and the list price calculated for them. This will help the engineering head select the particular product edition to select and enhance according to his future roadmap.

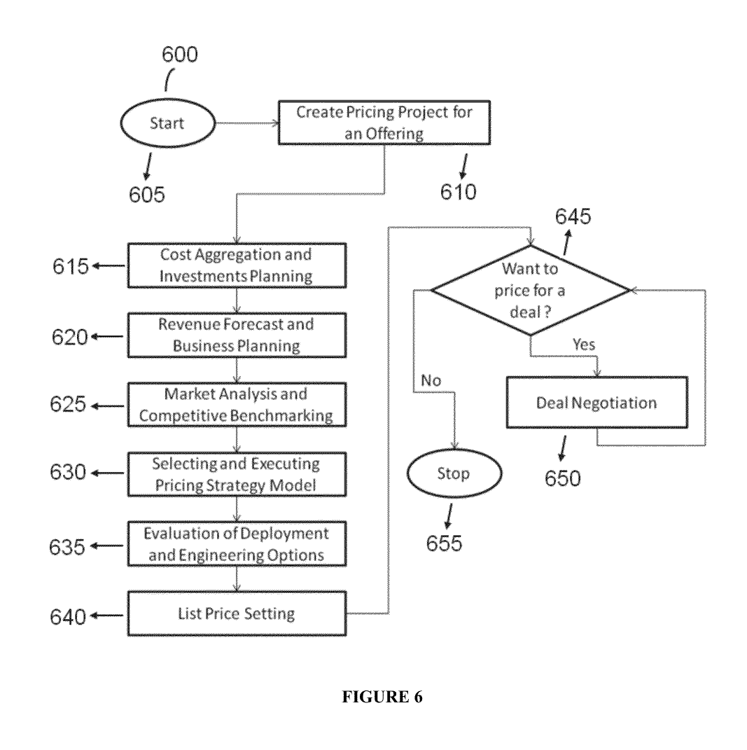

A FIG. 6 illustrates a process flow for a typical pricing project (600) executed using the DMMPM. The process starts with the Business manager logging into the DMMPM system (102) and initiating the pricing project (610). The Business manager then searches and selects the users to be included in the project. The Business Manager also enters values for the global variables to be used throughout the project. The users are then provided access to various roles or provided access to modules like Cost Aggregation and Investment Planning (615). At the end of the first step a workflow is created for pricing the offering, which includes inputs from various stakeholders.

After the first step, at least one of the users would get notification for providing inputs to the following modules Cost Aggregation and Investment Planning (615), Revenue Forecast and Business Planning (620), Evaluating Delivery and Engineering Options (635) and Market Analysis and Competitive Benchmarking (625). In one of the embodiments, these four steps can be executed in parallel by four or more stakeholders. In an alternate embodiment, the steps can be executed in sequence of a Cost Aggregation and Investment Planning (615), a Revenue Forecast and Business Planning (620), a Market Analysis and a Competitive Benchmarking (625) and then an Evaluating Product and Engineering Options (635). These four steps are collectively referred to as collecting preliminary information.

In the Selecting and Executing a Pricing Strategy Model step (630), at least one user provides a set of quantitative and qualitative inputs about the maturity of the product, market analysis and buyer's behaviour. Based on the input, the system does the fitment of pricing model in a percentage scale and recommends the best-fit pricing strategy.

In a List Price Setting step (640), a price indicator is tweaked to generate the list price based on parameters including but not limited to corporate objectives, economic scenarios, risk perception, psychological inputs and overall gut feel of the stakeholders especially the Business manager. In one of the embodiments, the Business manager creates various scenarios using the inputs provided till now, past prices and scenarios, and corporate objectives. These scenarios are then translated into the metrics controlled by other stakeholders and subsequently approved by them.

The next step, checks are executed to ascertain whether a price for a specific deal has to be calculated or not (645). This input is provided by the user mapped to the Sales Manager role for offering. If the price for a specific deal needs to be calculated, the Deal Negotiation step (650) is executed. In the Deal negotiation, step the Sales manager and Business manager fill in parameters to make the list price more suitable for a particular customer. The price Negotiation step is repeated whenever a Sales manager has a new deal to price.

### WORKING EXAMPLE OF THE INVENTION

A working example is illustrated using FIG. 6, as a reference. In an embodiment, a pricing project (600) is implemented in an IT industry scenario, wherein the pricing for an Enterprise Data Management (EDM) product is estimated using the DMMPM. The implementation starts (605) with the Business manager logging into the DMMPM system hosted on a server and creating a pricing project for an offering (610). The project initiation involves providing details for an offering (610) about the product into the model's basic info component, which includes offering name, overview of the functionality, version number, the average deal size for the product, organizational details. A set of global variables that are used throughout the project are also entered. In one of the embodiment, the global variables are currency exchange rates, billing rates across geographies, standardized costs for various items, cost of capital, inflation rate, and standardized mark-up for 3rd party components.

For the present example, that is implementing the system of the present application in an IT environment, the pricing initiation step begins with entering details of the IT product that needs to be priced has shown in the Table A; followed by selecting and entering into the system, revenue inflows through license sales and professional service charges, average deal size, and planned effort as shown in Table B.

TABLE A
Details of Product to be Priced

| Product Details | Enter Values |
|---|---|
| Offering Name | Enterprise Data Management Platform |
| Organization | EDM Division |
| Product Version | 5.2 |
| User Name | Mr. Business owner |
| Role | Business owner |
| Contact | +911111111111 |
| Email | product.owner@xyz.com |

TABLE B
Average Deal Size of the Product

| Average Deal Parameters | Enter Values |
|---|---|
| Sample Deal Size | 10,000,000 USD |
| Planned Person year effort of the Deal | 100 Person Years |
| Planned Person year using the Solution | 100 Person Years |
| Time duration of the Deal | 3 Years |
| Onsite Offshore Ratio | 20-80 |
| Geography | India |
| Pricing Paradigm | License Revenue supported by |
| | Professional Services |

The Business manager searches and selects users that are to be included in a project. The users are provided access to various roles or provided access to various modules at the Cost Aggregation and Investment Planning step (615). The access can be read access, write or modify access.

At the end of execution of the first step, a workflow is created for pricing the offering, which includes the inputs from various stakeholders. A notification is also sent out to stakeholders to log into the system and provide inputs.

In one of the embodiments, Cost Aggregation and Investment Planning step (615), Revenue Forecast and Business Planning step (620), Evaluating Delivery and Engineering Options step (635), and Market Analysis and Competitive Benchmarking step (625) are executed in parallel by four or more stakeholders. In an alternate, embodiment the steps can be executed in a sequence: Cost Aggregation and Investment Planning (615), Revenue Forecast and Business Planning (620), Market Analysis and Competitive Benchmarking (625) and then Evaluating Product and Engineering Options (635). These four steps are collectively referred to as collecting preliminary information.

In the Cost Aggregation and Investment Planning step (615) the values for various types of cost associated with designing, building, delivering and maintaining the offering are entered by the at least one user. The costs are collated for the cost incurred and projected future costs. In one of the embodiments, the user classifies the cost into Investments, Operational expenses and Expenses associated with the delivery of project and provides inputs for present value and projections for the next 5 years. For each of these classifications, the user sub-categories them into resource cost, materials cost, and infrastructure cost and even further into what is fixed cost, variable with time and units sold.

In the present example, for EDM product, investments and running costs are entered into the Cost Aggregations and Investments Planning Component of system. The Cost Aggregations and Investments Planning step (615) in case of EDM product begins with capture of initial investments, followed by operational cost, and finally project based cost (the cost of deploying the EDM product into the customer's environment), as illustrated by Table C, Table D and Table E. Investment details for 5 years are captured as illustrated in the Table C below; the efforts for Year 0 are associated with the historical investments made to the product.

TABLE C
Capturing the Investment made in Building the Product

| | Default | | | | |
|---|---|---|---|---|---|
| Parameters | Unit | Year 0 | Year 1 | Year 2 | Year 5 |
| Research & Development | USD | 1,050,000 | 1,050,000 | 1,050,000 | 1,050,000 |
| Effort - Base Version | | | | | |
| Business Analyst | Person Hrs. | 2,000 | 2,000 | 2,000 | 2,000 |
| Project Manager | Person Hrs. | 2,000 | 2,000 | 2,000 | 2,000 |
| Technical Architect | Person Hrs. | 2,000 | 2,000 | 2,000 | 2,000 |
| Developer/Test Engineer | Person Hrs. | 25,000 | 25,000 | 25,000 | 25,000 |
| Offshore | | | | | |
| Sr Developer/Test manager | Person Hrs. | 5,000 | 5,000 | 5,000 | 5,000 |
| Offshore | | | | | |
| Developer/Test Engineer | Person Hrs. | 3,000 | 3,000 | 3,000 | 3,000 |
| Onsite | | | | | |
| Sr Developer/Test manager | Person Hrs. | 2,000 | 2,000 | 2,000 | 2,000 |
| Onsite | | | | | |
| Hardware and Infrastructure | USD | 1,000,000 | 200,000 | 200,000 | 200,000 |
| Procurement | | | | | |
| Development Software | USD | 200,000 | 0 | 0 | 0 |
| Procurement | | | | | |
| Technology and License | USD | 200,000 | 50,000 | 50,000 | 50,000 |
| Procurement | | | | | |
| IP Protection Cost | USD | 100,000 | 0 | 0 | 0 |
| Training, Learning and | USD | 100,000 | 100,000 | 100,000 | 100,000 |
| Development | | | | | |
| Miscellaneous (Travel, Other | % Dev Effort | 10 | 5 | 5 | 5 |
| Operational Costs) | | | | | |
| Total Developmental Cost | USD | 2,915,000 | 1,470,000 | 1,470,000 | 1,470,000 |
| Aggregated Developmental | USD | 7,002,341 | | | |
| Cost | | | | | |

The operational cost includes sales & marketing, and support overheads, which are entered into the system as illustrated by Table D.

TABLE D
Operational Cost

| | | | | | |
|---|---|---|---|---|---|
| | Default | | | | |
| Parameters | Unit | Year 0 | Year 1 | Year 2 | Year 5 |

Sales and Marketing Costs
Sales/Presales Costs

| | | | | | |
|---|---|---|---|---|---|
| Cost of Sales | USD | 400,000 | 400,000 | 600,000 | 600,000 |
| Team | | | | | |
| Sales Expenses | USD | 50,000 | 50,000 | 75,000 | 75,000 |

Marketing Costs

| | | | | | |
|---|---|---|---|---|---|
| Events | USD | 100,000 | 200,000 | 200,000 | 200,000 |
| Marketing | USD | 50,000 | 50,000 | 50,000 | 50,000 |
| Collateral | | | | | |
| Media | USD | 50,000 | 100,000 | 100,000 | 100,000 |
| Marketing | | | | | |

Support Overheads

| | | | | | |
|---|---|---|---|---|---|
| Product | USD | 0 | 0 | 0 | 0 |
| Warranty | | | | | |
| Hosted/Shared | USD | 0 | 0 | 0 | 0 |
| Services | | | | | |
| Infrastructure | | | | | |
| Total Sales and | USD | 900,000 | 1,050,000 | 1,425,000 | 1,425,000 |
| Marketing | | | | | |
| Costs | | | | | |
| Total Sales and | USD | 4,435,509 | | | |
| Marketing | | | | | |
| Costs | | | | | |

The project specific cost allows identifying the cost of deployment per project. From the Table E illustrated below the net present value for EDM product is USD 8244523.

TABLE E
Project Specific Cost

| | | | | | |
|---|---|---|---|---|---|
| | Default | | | | |
| Parameters | Unit | Year 0 | Year 1 | Year 2 | Year 5 |

Marginal Costs Sold

| | | | | | |
|---|---|---|---|---|---|
| Sub | USD | 300,000 | 100,000 | 50,000 | 50,000 |
| Components/ | | | | | |
| Vendor | | | | | |
| Licensing Cost | | | | | |
| AMC Support | USD | | 25,000 | 12,000 | 12,000 |
| Cost | | | | | |
| Implementation | USD | 3,156,000 | 2,367,000 | 2,367,000 | 0 |
| and | | | | | |
| Customization | | | | | |
| Costs | | | | | |
| Business | person | 3,200 | 2,400 | 1,200 | 1,200 |
| Analyst | hours | | | | |
| Project | person | 3,200 | 2,400 | 1,200 | 1,200 |
| Manager | hours | | | | |
| Technical | person | 6,400 | 4,800 | 2,400 | 2,400 |
| Architect | hours | | | | |
| Developer/Test | person | 56,000 | 42,000 | 21,000 | 21,000 |
| Engineer | hours | | | | |
| Offshore | | | | | |
| Sr Developer/ | person | 4,000 | 3,000 | 2,000 | 2,000 |
| Test manager | hours | | | | |
| Offshore | | | | | |
| Developer/Test | person | 1,600 | 1,200 | 1,000 | 1,000 |
| Engineer | hours | | | | |
| Onsite | | | | | |
| Sr Developer/ | person | 15,200 | 11,400 | 5,000 | 5,000 |
| Test manager | hours | | | | |
| Onsite | | | | | |
| Travel | USD | 160,000 | 120,000 | 60,000 | 60,000 |
| Integration | USD | 10,000 | 0 | 0 | 0 |
| Costs | | | | | |
| Consulting | USD | 8,000 | 0 | 0 | 0 |
| Deployment | USD | 5,000 | 0 | 0 | 0 |
| Hardware | | | | | |
| Training | USD | 5,000 | 0 | 0 | 0 |
| Inflation @ 9% | % | | 235,0008 | 114,516 | 114,516 |
| Total | USD | 3,644,000 | 2,847,000 | 1,386,916 | 1,386,916 |
| Marginal | | | | | |
| Costs | | | | | |
| Total Cost | USD | 8,244,523 | | | |

During the execution of Revenue Forecasting and Business Planning step (620) the system is configured to capture details for projected sales volumes, break even period and projected service revenues per deal. The projected service revenue per deal is also captured into the system based on historical rates and a sizing of the efforts involved.

Sales projections for 5 years are captured as illustrated by table F, and based on these values a base unit price of EDM product is calculated. The unit price is optimized for various types of licensing options entered by the user based on pricing paradigm, and average deal size mentioned in the basic info component.

TABLE F
Sales Volume Projection

| Parameter | Year 0 | Year 1 | Year 2 | Year 5 |
|---|---|---|---|---|
| Enterprise Licenses | 2 | 5 | 20 | 50 |
| Server Licenses | 10 | 25 | 8 | 8 |
| Processor Licenses | 50 | 100 | 40 | 40 |
| User based Licenses | 800 | 1,500 | 500 | 500 |
| Projected No. Of Deals | 18 | 35 | 30 | 40 |

The breakeven period along with projected sales volume is captured to determine a base unit cost for EDM product, shown in table G.

TABLE G
Product Roadmap

| Break Even Period | Default units | Value (in years & months) | | | |
|---|---|---|---|---|---|
| Years to Break Even | Years & months | 1 | Years | 6 | Months |

Projected sales revenue and average service revenue for EDM accrued in a deal captured as shown in Table H.

TABLE H
Projected Service Revenue per Deal

| Revenue Projection - Per Deal | Default units | Value |
|---|---|---|
| AMC Revenue | USD | 500,000 |
| Solution Customization | USD | 500,000 |
| Implementation & Integration | USD | 4,000,000 |
| Consulting and Professional Services | USD | 3,000,000 |
| Training | USD | 250,000 |
| Total | USD | 8,250,000 |
| Total Service Revenue | USD | 8,250,000 |

From the parameters captured above, sales volumes are forecasted within which the product will breakeven, shown in table I.

TABLE I
Breakeven Volume

| Parameter | Unit | Value |
|---|---|---|
| Projected Enterprise Licenses to be sold over | Licenses | 30 |
| 1 years & 6 months | | |
| Project Specific Deals over 1 years & 6 months | Deals | 53 |

From the various parameter captured by DMMPM for the EDM product the system provides a cost that would be involved over the breakeven period shown in table J.

TABLE J
Total Cost Over Breakeven Period

| Parameter | Unit | Value |
|---|---|---|
| Total Expenses (Aggregated) | USD | 5,741,039 |

The cost over breakeven period is divided per projected license sale over the breakeven timeframe to calculate the base price/unit. The calculated base price/unit is illustrated in the table K.

TABLE K
Base Unit Link Price

| Parameter | Default Unit | Value |
|---|---|---|
| Enterprise License | USD | 191,368 |
| Per Server License | USD | 19,349 |
| Per Processor License | USD | 12,381 |
| Per User License | USD | 1,914 |

In the next step of Market Analysis and Competitive Benchmarking step (625) the values for various parameters about the market and competing products are entered by at least one user. In one of the embodiment, the Marketing manager provides this value. In the Market Analysis and Competitive Benchmarking step (625) each individual functional and non-functional features are rated. The Per Component Price Evaluation of the System is calculated as a function of the total weightage of the feature in the system, the individual complexity/weightage of the feature in the market and the costs associated with the component. The input structure for the sample scenario for EDM product is illustrated below.

Major competition for EDM products are listed below in table L. The applicable Enterprise wide features price for each of the competitive products is inputted into the system.

TABLE L

| Enter Competition | | Competitor | Competitor | Competitor |
|---|---|---|---|---|
| Name | XYZ | 1 | 2 | 3 |
| Enter Product Name | EDM | Product 1 | Product 2 | Product 3 |
| | Product | | | |
| Enter Full Features | | 528,000 | 125,000 | 104,000 |
| Price (Enterprise) | | | | |
| Deal Presence? | | [symbol] Present | [symbol] Present | [symbol] Present |

The following table M shows an aggregated view of the major functional components associated with the system for pricing EDM product.

TABLE M

| | Tools | | | | | |
|---|---|---|---|---|---|---|
| Tools Class | Capabilities | | | | | |
| Core EDM | Enterprise | Market | Standard | Differentiated | Differentiated | $85,000.00 |
| Engine | Data Model | Leading | | | | |
| (Aggregated) | Management | | | | | |
| | Core | Basic | Standard | Standard | Standard | |
| | Enterprise | | | | | |
| | Services | | | | | |
| | Enterprise | Differentiated | Market | Basic | Standard | |
| | Meta Data | | Leading | | | |
| | management | | | | | |
| | Master Data | Not Present | Standard | Not Present | Standard | |
| | Storage | | | | | |
| | Analytics | Standard | Standard | Standard | Standard | |
| | Adapters | Basic | Market | Not Present | Standard | |
| | | | Leading | | | |
| Non | Security | Differentiated | Basic | Basic | Market | $56,000.00 |
| Functional | | | | | Leading | |
| Parameters | Integration | Standard | Basic | Basic | Market | |
| (Aggregated) | | | | | Leading | |
| | Collaboration | Standard | Basic | Basic | Market | |
| | | | | | Leading | |
| | Interoperability | Market | Differentiated | Basic | Differentiated | |
| | | Leading | | | | |
| | Performance | Basic | Basic | Basic | Standard | |
| | Usability | Standard | Basic | Basic | Standard | |
| | Brand | Standard | Basic | Basic | Standard | |
| | Presence | | | | | |
| | Channels | Basic | Basic | Basic | Standard | |

In the Selecting and Executing Pricing Strategy Model step (630), at least one user rates the product for a set of quantitative and qualitative criteria concerning the maturity of the product, market analysis and buyer behaviour. The system then recommends the pricing strategy model to be executed. The user can follow the recommendation provided by the system or select some other pricing model to execute. A Business owner rates his product features, its competitiveness in the market and the extent of customer need it is fulfilling. Based on the ratings for each question, the system calculates the fitment of each pricing model for product/service. The system computes percent wise fitment of each pricing model for product/service and thereby recommends the best-fit pricing model that can be used for pricing.

Illustration for Selecting and Executing Pricing Strategy Model step (630) w.r.t. EDM with sample questions is given below in the table N, table O, and table P with the recommended model for pricing EDM in table Q.

The following table N is an illustrative list (including but not limited to) product specific considerations for selecting the right pricing strategy.

TABLE N
Product Criteria

| | | Select |
|---|---|---|
| | | Score |
| Criteria | Scale explanation | (1-5) |
| Offering Type | 1. Business Application | 2 |
| | 2. Integrated Software Platform | |
| | 3. Standalone Tool | |
| | 4. Professional/IT Services Offering | |
| | 5. Project Specific Development | |
| Standalone/Bundled Offering? | 1. Loose Package | 3 |
| | 2. Data/Process inter-Connected | |
| | components | |
| | 3. Loosely Coupling components | |
| | 4. Close Coupling Components | |
| | 5. Standalone Application | |
| Is the solution/product/service | 1. Highly Unmet Need. Could be | 3 |
| addressing a critical unmet | Strategic | |
| Customer Requirement for a specific | 2. High Need. Critical | |
| Need? | 3. Required Need. Might not be strategic | |
| | and might not have a strict timeline. | |
| | 4. General Need with a solve by date | |
| | 5. General Need. Not much critical | |
| Good awareness of the factors (risk | 1. High | 2 |
| factors, market scenarios, etc) that | 5. Low | |
| can impact the outcome of the | | |
| service e.g. dependency on external | | |
| vendor, market risk | | |
| Can the outcome of our | 1. Yes | 2 |
| service/product when placed in | 3. Partially | |
| Customer Environment and use be | 5. No | |
| “Clearly” measured/quantified? | | |

The following table O captures competitiveness of the product within a market.

TABLE O
Product Service Maturity

| | | Select |
|---|---|---|
| | | Score |
| Criteria | Scale explanation | (1-5) |
| Market Awareness of | 1. Minimal | 1 |
| Offering | 5. Excellent | |
| Do we have IP | 1. Highly Sustainable Technology/ | 3 |
| Protection for our | Market Advantage | |
| solution? Is our | 2. Strong Technology - No | |
| Technological | Competition expected for some time. | |
| Positioning highly | 3. Highly Competitive, many players | |
| sustainable | entering | |
| | 4. Same advantage shared by 2-3 | |
| | players | |
| | 5. Commodity/Others own many | |
| | technological barriers in the market | |
| Analyst Ratings have | 1. Indifferent | 4 |
| distinct Market and | 5. Leadership | |
| Expert evaluation of | | |
| the offering | | |
| Strong and Marketable | 1. Not Present | 2 |
| 1. Customer feedback/ | 5. Excellent | |
| References | | |
| 2. Collaterals, Case | | |
| Studies, Testimonials, | | |
| Technological | | |
| Community Presence | | |
| Market Segmentation by | 1. Cost Driven Market - Many | 4 |
| Profitability | Vendors have similar offering | |
| | 2. Low Cost, with some need based | |
| | 3. Subjective to the Customer within | |
| | the market | |
| | 4. Broadly Segmented market, with | |
| | distinct needs | |
| | 5. Niche Valued Market - Highly | |
| | Differentiated with Specific Needs | |
| Domain expertise | 1. Low | 3 |
| | 3. Neutral | |
| | 5. High | |

The following criteria listed in the table P, are used to input customer aligned specific parameters into the system.

TABLE P
Customer Alignment

| | | Select |
|---|---|---|
| | | Score |
| Criteria | Scale explanation | (1-5) |
| Is the solution aligned to | 1. Internal Process - Not | 3 |
| customer' core business | Market Facing | |
| offerings (source of | 3. Internal To Organization, | |
| differentiation, market | but substantial | |
| facing for the client)? | 5. Market Facing, | |
| Is the Solution Replacing an | 1. Replacement | 4 |
| existing solution or Process? | 3. Can't determine | |
| | 5. New Implementation | |
| What level we have access in | 1. High Level Access/ | 3 |
| the organization/Customer? | Strategic | |
| What Kind of Relationship | 3. Limited Access | |
| do we enjoy with the | 5. Project Specific/Issue | |
| organization/Customer | Oriented | |
| Does client require Faster time | 1. Faster Time to Market | 1 |
| to market? | 3. Can't Say | |
| | 5. No specific requirement | |
| Are the savings accurately | 1. Highly quantifiable | 3 |
| quantifiable for the client? | 3. Less Quantifiable | |
| Can the client accurately | 5. Cannot be quantified | |
| quantify its savings from the | | |
| product/solution | | |
| Is the Product/Solution Highly | 1. Highly Customizable - | 4 |
| Customizable and various | Various Versions can be | |
| Versions and Flavors can be | made from the solution | |
| used to tackle different needs? | and priced accordingly | |
| | 2. Core Functionality is the | |
| | major functionality- Small | |
| | Customizations can be easily | |
| | done. | |
| | 3. Solution requires basic and | |
| | premium models. Not much | |
| | Customization in our Business | |
| | Model | |
| | 4. Customization Not | |
| | Preferable | |
| | 5. Customization of | |
| | product/solution risky to the | |
| | business outcomes/goals | |
| Overall Applicability of | 72% | |
| Pricing Strategy | | |

Following Table Q reveals the percentage fitment for each of the pricing models, with recommending the best fit.

TABLE Q
Applicability

| Pricing Strategy | Score |
|---|---|
| Cost Based Strategy | 25% |
| Value Based Strategy | 55% |
| Market Based Strategy | 72% |
| Outcome Based Strategy | 60% |

Recommended Pricing Strategy - Market Based

It can be inferred from the recommended market based strategy for the EDM product that:
There are multiple players in the market.
Customers value a niche functional components of an EDM tool and are more likely to pay premiums for the exact features that they require into their environments.
The environment is competitive with equivalent power of the buyers and sellers.

During execution of Evaluation of Deployment and Engineering Options step (635) the values for various parameters relating to delivery, standard product configurations, service quality, and support are entered by at least one user. In one of the embodiment, the Delivery manager provides these values. It also integrates the discounting guidelines that capture the types of discounts for winning the deal.

Some of the sample tables (Table R, Table S, Table T, Table U, Table V, Table W, and Table X) are illustrated below associated with EDM product.

TABLE R
Consulting Rates

| | Rate | | |
|---|---|---|---|
| Consulting | (in $) | Hrs | Cost |
| Business Analyst | 100 | 48 | $4,800 |
| Project Manager | 130 | 48 | $6,240 |
| Senior Support Engineer | 70 | 48 | $3,360 |
| Senior Technical Architect | 100 | 48 | $4,800 |
| Training consultant | 50 | 48 | $2,400 |
| Tech Lead - Offshore | 40 | 48 | $1,920 |
| Tech Lead - Onsite | 60 | 48 | $2,880 |
| Senior Software Engineer - | 40 | 48 | $1,920 |
| Offshore | | | |
| Senior Software Engineer - | 60 | 48 | $2,880 |
| Onsite | | | |
| Software Engineer - | 35 | 48 | $1,680 |
| Offshore | | | |
| Software Engineer - Onsite | 50 | 48 | $2,400 |
| Project Leader | 50 | 48 | $2,400 |

| | |
|---|---|
| Total (Consulting) | $37,680 |

TABLE S
Final Licensing Based List Price

| | | Enter | |
|---|---|---|---|
| License Type based on | in $ | Units | Total |
| Enterprise (Software License Slab) | $1,188,643 | 1 | $1,188,643 |
| Server | $33,955 | 10 | $339,550 |
| Processor | $14,096 | 50 | $704,800 |
| User | $11,886 | 10 | $118,860 |
| Total List Price | | | $2,351,853 |

TABLE T
Software License Based Cost with AMC

| Software License | | | |
|---|---|---|---|
| With AMC | in $ | Quantity | Total |
| With AMC | $552,506 | 1 | $552,506 |
| Without AMC | $476,298 | 1 | $476,298 |

| | |
|---|---|
| Total Software License Cost with applicable AMC | $1,028,805 |

TABLE U
Discounting Guidelines

| Discount Types | Total |
|---|---|
| Quantity Discount | $20,000 |
| Discount - | $10,000 |
| Channel/Geography | |
| Strategic Discount | $40,000 |
| Total Discount | $70,000 |

TABLE V
Training Cost

| | Unit Price | | |
|---|---|---|---|
| Activities | (USD) | Quantity | Total |
| Classroom | $800 | 5 | $4,000 |
| Online | $400 | 6 | $2,400 |
| Travel | $200 | 7 | $1,400 |
| Total (Training) | | | $7,800 |

TABLE W
Support Cost

| | Unit Price | | |
|---|---|---|---|
| Activities | (USD) | Quantity | Total |
| Classroom | $800 | 5 | $4,000 |
| Online | $400 | 6 | $2,400 |
| Travel | $200 | 7 | $1,400 |

| | |
|---|---|
| Total (Training) | $7,800 |

TABLE X
Hardware Cost

| | Unit Price | | |
|---|---|---|---|
| Hardware | (USD) | Quantity | Total |
| CPU Hardware | $20,000 | 5 | $100,000 |
| Servers | $50,000 | 3 | $150,000 |
| Modem | $250 | 4 | $1,000 |
| Extraordinary power supply | $2,000 | 3 | $6,000 |
| Backup Systems | $1,000 | 3 | $3,000 |
| Disaster Recovery Systems | $3,000 | 1 | $3,000 |
| Disk Storage | $250 | 30 | $7,500 |
| Tape Backup | $200 | 40 | $8,000 |
| Switching devices | $75 | 5 | $375 |
| Routers | $700 | 1 | $700 |
| Racks | $1,000 | 4 | $4,000 |
| Total (Hardware) | | | $283,575 |

In the List Price Setting (640) step, the price indicator is tweaked to generate a credible deal price/the list price based on parameters including but not limited to corporate objectives, economic scenarios, risk perception, psychological inputs and overall gut feel of the stakeholders especially the Business manager. In one of the embodiments, the Business manager creates various scenarios using the inputs provided till now, past prices and scenarios, and corporate objectives. These scenarios are then translated into a metrics controlled by other stakeholders and subsequently approved by them.

Given below are some illustrative views generated for EDM product after taking input from the system. With the help of table Y and table Z shown below, the Sales Manager of an EDM can target the maximum allowable discount for a customer to breakeven under various scenarios (i.e. worst case, average case, and best case scenarios).

TABLE Y
Year wise Investment & Volume Projections

| Overall Investment & Sales | Total (Year 0 | | | | |
|---|---|---|---|---|---|
| Volumes Details | to Year 5) | Year 0 | Year 1 | Year 2 | Year 5 |
| Development Cost | 6,271,341 | 46% | 20% | 18% | 0% |
| Project Specific Costs (Per Project) | 8,244,523 | 44% | 30% | 26% | 0% |
| Operational Cost | 3,827,509 | 24% | 24% | 28% | 0% |
| Total Investment Costs (Overall | 10,098,850 | 38% | 22% | 22% | 0% |
| Product) | | | | | |
| Normalized Sales Target | 30 | 33% | 67% | 0% | 0% |
| Breakeven Cost of Enterprise Data | 191,368 | | | | |
| Management Platform | | | | | |

TABLE Z
Comparison of Outputs of the various Pricing Strategies

| Parameters | Cost Based | Value Based |
|---|---|---|
| Price of Enterprise Data Management | 1,037,356 | 2,975.912 |
| Platform | | |
| Margins | 82% | 475% |

The table AA illustrates a sample view as viewed by the Business owner.

TABLE AA
Sample Business owner View

| | Sales Scenario Selector | | |
|---|---|---|---|
| | Worst | Average | Best |
| | Case | Cases | Case |
| | 50% | 100% | 150% |
| | Target | Target | Target |
| Total Sales Target | 15 | 30 | 45 |
| Base Cost per Unit | 382,736 | 191,368 | 127,579 |
| Margins over Base Cost per Unit | 171% | 442% | 713% |
| List Price to support Markup | 2,074,429 | 1,037,356 | 1,037,356 |
| Max Discounts allowed to support | 0% | 0% | 33% |
| Markup | | | |

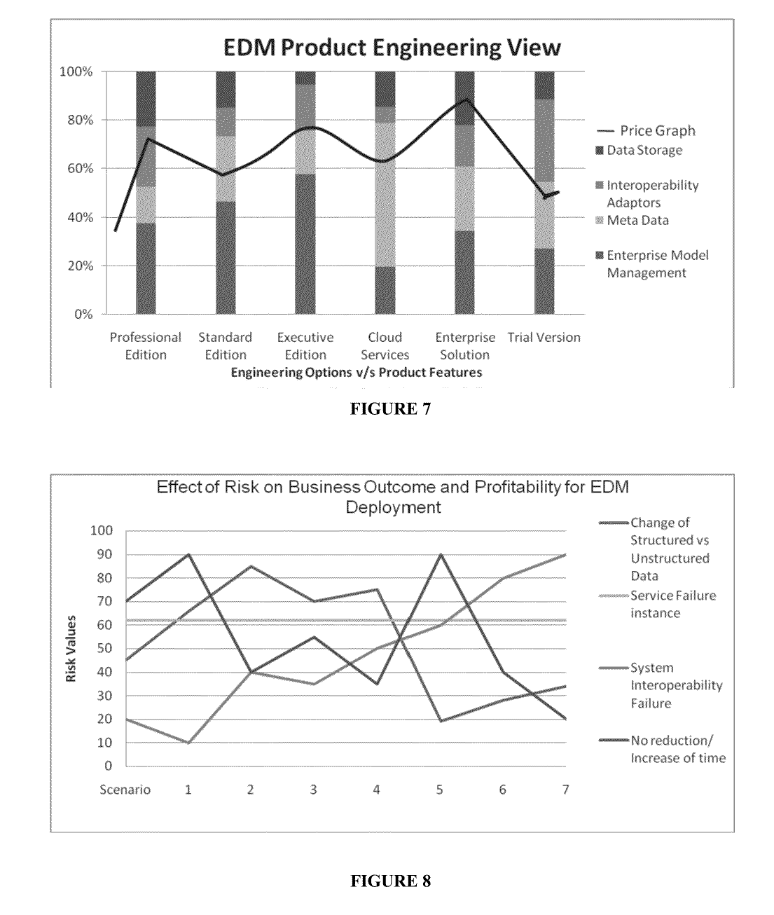

Through the sample graphical representation as illustrated by FIG. 7, engineering features of EDM product are depicted. The engineering view helps the engineering head to view functional breakup of the various product editions and the list price calculated for them. This helps the engineering head select the particular product edition and enhance according to his future roadmap.

The system provides various scenarios to aid in deploying the solution, which are generated by assessing risk options during deploying the product. The deployment view summarizes key deployment options, the major milestones and agreed SLAs and the overall Operational costs for the organization. There are three major risk parameters service instance failure, system interoperability failure and no reduction/actual increase in the overall enterprise effort to do data management. The FIG. 8, illustrates how combinations of these risks will affect the business outcome.

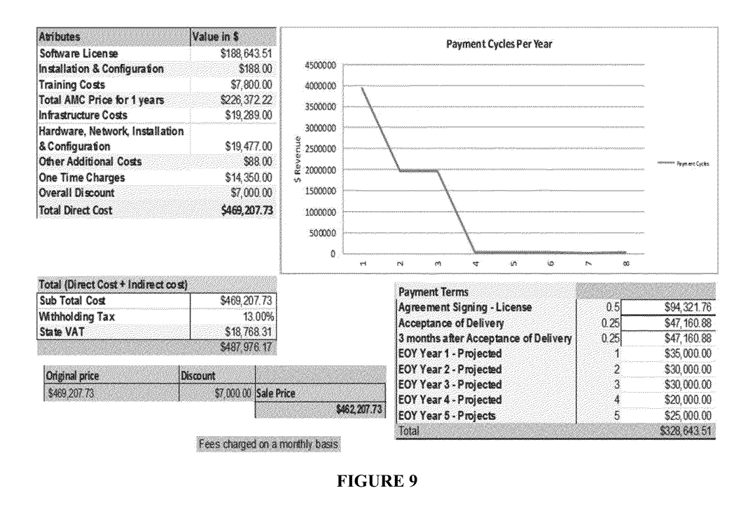

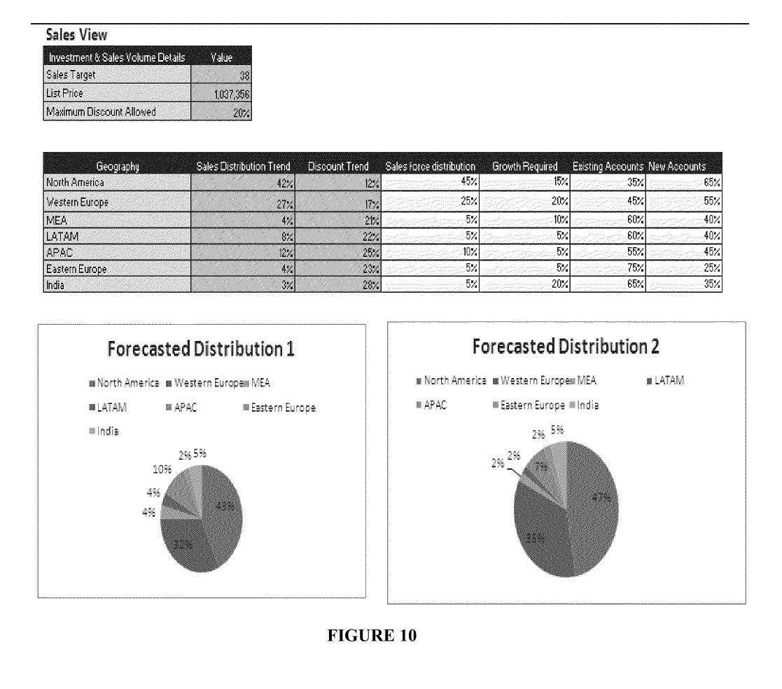

FIG. 9, illustrates revenue realization context for the Deployment Manager. From the illustration according to FIG. 10, a sales manager can plan the sales target across multiple geographical markets and channels. From the FIG. 10, the Sales manager receives a target along (38) with a List price/Credible price (around USD 1 million) and maximum discount allowed (20%), it also shows the sales distribution trend and discount trend from past data. If no historic data is present, the system either allows the sales manager to enter them for the first time or assumes values from similar offerings present in the system.

The next step executed checks whether the price for a specific deal has to be calculated or not (645). The user mapped to the Sales manager role for offering provides this input. If the price for a specific deal needs to be calculated, the Deal Negotiation (650) step is executed. In the Deal negotiation (650) step the Sales manager and Business manager fill in parameters to make the credible deal price/list price more suitable for a particular customer. The price Negotiation (650) step is repeated whenever a Sales manager has a new deal to price.

1. A system for dynamically computing a deal price for a deal, the system comprising:
a processor (202); and
a memory (204) coupled to the processor (202), wherein the memory (204) comprises a plurality of modules being executed by the processor, the plurality of modules comprising:
a presentation layer module configured to capture and display
a plurality of first data sets during deal initialization; and
a plurality of second data sets from at least one stakeholder of a plurality of stakeholders, each stakeholder accessing at least one customized view of at least one first data set of the plurality of the first data sets and at least one second data set of the plurality of second data sets;
integration module configured to ensure sanctity of the plurality of first data sets and the plurality of second data sets in an integrated pricing context by
correlating the plurality of first data sets, the plurality of second data sets, and metrics synchronized across each customized view of each stakeholder of the plurality of stakeholders; and
combining the plurality of first data sets, the plurality of second data sets, and the metrics comprising outputs of a plurality of analytical utilities to provide further insights in computing the credible deal price;
a preliminary information processing module configured to process the plurality of first data sets to calculate components being displayed on the customized view, wherein the components comprises variables being invoked using a set of rules, and wherein the variables derive utilizable information for each stakeholder of the plurality of stakeholders, thereby facilitating in at least one of
an informed decision making, and
validating decisions of the one or more stakeholders of the plurality of stakeholders in context of the one or more stakeholders,
and wherein the customized view is invoked at least one of iteratively and at discrete points of time
a plurality of pricing models, each pricing model of the plurality of pricing models has affinity to one or more data elements of the plurality of first data sets, the plurality of second data sets, wherein each pricing model of the plurality of pricing models comprises at least one of different workflows, computing models, and deal parameters in order to derive a right premium to be charged to a customer;
a selecting pricing strategy module configured to
recommend a best fit pricing strategy by executing an applicability evaluation computation on each of the plurality of pricing models with respect to a plurality of qualitative parameters, wherein the plurality of qualitative parameters comprises at least one of business context, maturity of an offering, and alignment to customer requirements; and
generate a comparative rating index for each pricing model of the plurality of price models based upon an applicability of the one or more pricing models to the integrated pricing context wherein the best fit pricing strategy comprises a set of decisions proposed in deriving a most optimum process for
calculating the right premium,
negotiating with the customer,
selecting right delivery parameters, and
achieving a collaborative approval from each stakeholder of the plurality of stakeholders with respect to objectives and constraints of the plurality of stakeholders;
a pricing engine module (226) configured to
execute dynamically
one of the best fit pricing strategy and a stakeholder approved pricing strategy across one or more pricing models of the plurality of pricing models,
workflows associated with the one or more pricing models of the plurality of pricing models, and
role based iterations associated with the one or more pricing models of the plurality of pricing models; and
integrate the at least one first data set of the plurality of first data sets, the at least one second data set of the plurality of second data sets, and a plurality of dynamic levers to collaboratively evaluate a deal price, wherein the plurality of dynamic levers comprises at least one of a risk, sales volume, profitability, product feature bundling and market competitiveness associated therewith the one of a product, a service, and a product-service offered;
determine a list price indicator comprising a set of indices and corresponding computed prices, wherein the set of indices comprises
at least one option around one of a product deployment, a service deployment, and a product-service mix deployment; and
at least one engineering option around one of a product deployment, a service deployment, and a product-service mix deployment;
a pricing strategy module configured to
execute the one or more second data sets of the plurality of second data sets; and
output the list price indicator;
a list price generator module configured to determine a list price commensurate with the list price indicator, wherein the list price is indicative of a value of one of the product, the service, and the product-service mix, and wherein the list price is determined by
using one of the one of the best fit pricing strategy and the stakeholder approved pricing strategy, and
synchronizing objectives and constraints of each stakeholder of the plurality of stakeholders with dynamic environmental factors to collaboratively approve and determine the list price; and
a deal negotiation module configured to derive the credible deal price commensurate with a plurality of third data set dynamically associated with time, scope and value realized there with the deal, wherein the time, the scope, and the value are individually defined by qualitative parameters and quantitative parameters, and wherein the scope is defined by
customer requirements quantified by the customer, and
a qualitative need analysis perceived for each customer requirement;
and wherein the value is defined by
quantitative benefits leveraged by the customer, and
a qualitative alignment of the product and service capabilities as perceived;
and wherein the time is indicative of
price considerations around cost of deployment, operating expenses, and financial considerations based upon time, and
a qualitative perception of execution capabilities and risks, wherein the qualitative parameters and the quantitative parameters specific to the deal override generic output to calculate the deal price, the right premium, and discounts calculated by a combination of both the qualitative parameters and the quantitative parameters;
and wherein the presentation layer module is further configured to logically
integrate data from the plurality of modules, wherein the data comprises the plurality of first data sets, the plurality of second data sets, historical data from one or more databases associated with the plurality of modules, and the metrics comprising outputs of the plurality of analytical utilities;
process the data analytically through integrated reports and dashboards; and
authorize one or more stakeholders of the plurality of stakeholders to selectively view the data and the integrated reports through a configurable permissions mapping mechanism.

2. The system of claim 1, wherein at least one customized view of the presentation layer module for the each stakeholder of the plurality of stakeholders corresponding to specific attribute associated to the each stakeholder in a value chain of an organization, and wherein the plurality of stakeholders comprises of the following but is not limited to business manager, a sales manager, an engineering manager, and a delivery manager.

3. The system of claim 1, wherein the at least one first data set of the plurality of first data sets is processed with pre-defined mathematical calculations related to at least one of cost aggregation, investment planning, revenue forecast, business planning, market analysis, competitive benchmarking and evaluating product, and engineering options.

4. The system of claim 1, wherein the at least one second data set of the plurality of second data sets comprises information pertaining to at least one of pricing strategy, associated pricing models, deployment, and engineering options, and wherein the deployment options comprises at least one of licensing, provisioning, and subscription modes of deployment, and wherein engineering options comprises a plurality of standard product, service, Service Level Agreements (SLA), and support configurations.

5. The system of claim 1, wherein the deal negotiation module is further adapted to evaluate and map at least one of the plurality of first data sets and the plurality of second data sets with various deployment and engineering options derive the deal price, and wherein the deal negotiation module is further adapted to consider timelines for delivery, type and quantity of deployed licenses, deployment environment, services to be provisioned or transport, training and consulting requirements for arriving at the deal price.

6. The system of claim 1, wherein the deal negotiation module is further adapted to capture and quantify customer perception for at least one factor selected from a group comprising a brand perception, a competitive positioning, or an alignment of the service/product.

7. The system of claim 1, wherein the plurality of third data set enables a scenario generator to create multiple scenarios based on the dynamic association with time, scope and value realized which then is provided to the plurality of stakeholder according to the attributes thereof, wherein the multiple scenarios are generated during a course of determining the deal price for one of the product, the service, and the product-service mix, and wherein the multiple scenarios are generated for key attributes comprising projected sales realization, product configuration, service level and business outcomes realization, deployment unit volume slabs, resource distribution.

8. The system of claim 1, wherein the plurality of first data sets, the plurality of second data sets, the plurality of third data sets, and customer perception are captured at predefined stages of the deal from the plurality of stakeholders by
facilitating a system level data integration that combines various inputs of the plurality of stakeholders in cascaded form with appropriate checks and alerts; and
assigning a predefined weight for input from each stakeholder and consolidating the input data at selective stages to provide intelligent price evaluation.

9. A system for dynamically computing a deal price in a transaction, to a customer according to one or more deployment parameters, the vendor operating in an organized environment communicatively coupled with a plurality of stakeholders, the system comprising:
a processor (202); and
a memory (204) coupled to the processor (202), wherein the memory (204) comprises a plurality of modules being executed by the processor, the plurality of modules comprising:
a presentation layer module configured to capture and display
a plurality of first data sets during deal initialization;
a plurality of second data sets from at least one stakeholder of a plurality of stakeholders, each stakeholder accessing at least one customized view of at least one first data set of the plurality of the first data sets and at least one second data set of the plurality of second data sets; and
a plurality of third data sets comprising time, scope and value for the transaction;
integration module configured to ensure sanctity of the plurality of first data sets and the plurality of second data sets in an integrated pricing context by
correlating the plurality of first data sets, the plurality of second data sets, and metrics synchronized across each customized view of each stakeholder of the plurality of stakeholders; and
combining the plurality of first data sets, the plurality of second data sets, and the metrics comprising outputs of a plurality of analytical utilities to provide further insights in computing the credible deal price;
a preliminary information processing module configured to process the plurality of first data sets to calculate components being displayed on the customized view, wherein the components comprises variables being invoked using a set of rules, and wherein the variables derive utilizable information for each stakeholder of the plurality of stakeholders, thereby facilitating in at least one of
an informed decision making, and
validating decisions of the one or more stakeholders of the plurality of stakeholders in context of the one or more stakeholders,
and wherein the customized view is invoked at least one of iteratively and at discrete points of time
a plurality of pricing models, each pricing model of the plurality of pricing models has affinity to one or more data elements of the plurality of first data sets, the plurality of second data sets, wherein each pricing model of the plurality of pricing models comprises at least one of different workflows, computing models, and deal parameters in order to derive a right premium to be charged to a customer;
a selecting pricing strategy module configured to
recommend a best fit pricing strategy by executing an applicability evaluation computation on each of the plurality of pricing models with respect to a plurality of qualitative parameters, wherein the plurality of qualitative parameters comprises at least one of business context associated with the transaction, maturity of an offering, and alignment to customer requirements; and
generate a comparative rating index for each pricing model of the plurality of price models based upon an applicability of the one or more pricing models to the integrated pricing context, wherein the best fit pricing strategy comprises a set of decisions proposed in deriving a most optimum process for
calculating the right premium,
negotiating with the customer,
selecting right delivery parameters, and
achieving a collaborative approval from each stakeholder of the plurality of stakeholders with respect to objectives and constraints of the plurality of stakeholders;
a pricing engine module (226) configured to
execute dynamically
one of the best fit pricing strategy and a stakeholder approved pricing strategy across one or more pricing models of the plurality of pricing models,
workflows associated with the one or more pricing models of the plurality of pricing models, and
role based iterations associated with the one or more pricing models of the plurality of pricing models;
integrate the at least one first data set of the plurality of first data sets, the at least one second data set of the plurality of second data sets, and a plurality of dynamic levers to collaboratively evaluate a deal price for the transaction, wherein the plurality of dynamic levers comprises at least one of a risk, sales volume, profitability, product feature bundling and market competitiveness associated therewith the one of the product, the service, and the product-service offered;
determine a list price indicator comprising a set of indices and corresponding computed prices, wherein the set of indices comprises
at least one option around one of a product deployment, a service deployment, and a product-service mix deployment; and
at least one engineering option around one of a product deployment, a service deployment, and a product-service mix deployment;
a pricing strategy module configured to
execute the one or more second data sets of the plurality of second data sets; and
output the list price indicator;
a list price generator module configured to determine a list price commensurate with the list price indicator, wherein the list price is indicative of a value of one of the product, the service, and the product-service mix, and wherein the list price is determined by
using one of the one of the best fit pricing strategy and a stakeholder approved pricing strategy, and
synchronizing objectives and constraints of each stakeholder of the plurality of stakeholders with dynamic environmental factors to collaboratively approve and determine the list price; and
a deal negotiation module configured to derive the credible deal price with reference to the transaction, commensurate with a plurality of third data set dynamically associated with time, scope and value realized there with the deal, wherein the time, the scope, and the value are individually defined by qualitative parameters and quantitative parameters, and wherein the scope is defined by
customer requirements quantified by the customer, and
a qualitative need analysis perceived for each customer requirement;
and wherein the value is defined by
quantitative benefits leveraged by the customer, and
a qualitative alignment of the product and service capabilities as perceived;
and wherein the time is indicative of
price considerations around cost of deployment, operating expenses, and financial considerations based upon time, and
a qualitative perception of execution capabilities and risks, wherein the qualitative parameters and the quantitative parameters specific to the deal override generic output to calculate the price, the deal price, the right premium, and discounts calculated by a combination of both the qualitative parameters and the quantitative parameters;
a scenario generator (244) configured to render one or more consolidated transactional scenarios associated therewith the transaction, including a plurality of dynamic levers associated therewith the transaction, and recommending at least one price model from the plurality of pricing models;
wherein the deal negotiation module is further configured to derive a negotiated deal price by
enabling multiple iterative discussions with the customer,
discussing around the third data set,
evaluating transactional scenarios at each iteration while selecting a final consolidated transactional scenario of the one or more consolidated transactional scenarios, wherein the final consolidated transactional scenario is optimized for the dynamic levers relevant to the consolidated transactional scenario to yield the negotiated deal price, and wherein the negotiated deal price comprises agreed deployment options around one of the product, the service, the product-service mix;
and wherein the presentation layer module is further configured to logically
integrate data from the plurality of modules, wherein the data comprises the plurality of first data sets, the plurality of second data sets applicable at the transaction, historical data from one or more databases associated with the plurality of modules, and the metrics comprising outputs of the plurality of analytical utilities;
process the data analytically through integrated reports and dashboards; and
authorize one or more stakeholders of the plurality of stakeholders to selectively view the data and the integrated reports through a configurable permissions mapping mechanism.

10. The system of claim 9, further comprising a repository for storing a plurality of acquired transactional scenarios, wherein each acquired transactional scenario provides a self-learning ability and to produce an intuitively dynamic price determination in a similar scenario.

11. The system of claim 9, wherein the credible deal price for each transaction is derived alternatively by intuitively applying the said acquired intelligence to the primary information of the transaction along with plurality of dynamic factors associated with market and offering.

12. The system of claim 9, wherein each dynamic lever is adapted to illustrate its impact on the transaction, and wherein each dynamic lever of the plurality of dynamic levers comprises of a risk, sales volume, profitability, product feature bundling and market competitiveness associated therewith the product/service offered.

13. The system of claim 9, wherein the consolidated transactional scenarios comprising of illustration of plurality of analytical output, deal price for each deployment option that comprises consideration of services, transactional charges and the financial options.

14. A method for dynamically computing a price in a at least one of a deal and a transaction instance during a deal negotiation, the method comprising:
aggregating, by a processor, a plurality of first data sets associated with the transaction instance, wherein the at least one first data sets are aggregated for a plurality of stakeholders, and wherein each of the first data set of the plurality of first data sets comprises information pertaining to cost projections, investment projections, market analysis, competitive benchmarking, revenue forecast, and business planning;
receiving, by the processor, feedback for the each of the first data set of the plurality of first data sets from each stakeholder of the plurality of stakeholders, wherein the feedback comprises the plurality of first data sets, a plurality of second data sets, and a plurality of third data sets;
assigning, by the processor, weightage to the feedback received from the plurality of stakeholders;
iterating dynamically, by the processor, the feedback with a plurality of pricing models hosted on a server, each pricing model of the plurality of pricing model is configured to dynamically optimize a pricing computation for the feedback, wherein each pricing model of the plurality of pricing models comprises at least one of different workflows, computing models, and deal parameters in order to derive a right premium to be charged to a customer;
mapping, by the processor, the plurality of pricing models so iterated with at least one dynamic lever to collaboratively evaluate a deal price for the transaction instance, wherein the plurality of dynamic levers comprises at least one of a risk, sales volume, profitability, product feature bundling and market competitiveness associated therewith the one of the product, the service, and the product-service offered; and
rendering, by the processor, one or more consolidated transactional scenarios associated therewith the transaction instance and recommending at least one price model to one or more devices connected therewith the server.

15. (canceled)

16. The method of claim 14, wherein the plurality of pricing models comprises of cost based model, outcome based model, market based model, and value based model.

17. (canceled)

18. (canceled)

19. The method for of claim 14, wherein the plurality of pricing models are iterated for a given deal transaction instance with feedback and further iterated with the plurality of dynamic levers for each dynamic scenario, each scenario is analyzed and displayed to the plurality of stakeholders enabling them to make informed decision.

20. The method of claim 14, wherein upon computation, for each scenario a negotiation point is recorded and inputs associated therewith each scenario are stored into the database, enabling the processor with cognitive intelligence acquisition and usage at each dynamic iteration.

21. The system of claim 9, wherein the negotiated deal price for the transaction instance is based on changes to the plurality of second data sets, the plurality of third data sets, and conditional changes to the weightage that corresponds to a pre-defined rating of an attribute of the plurality of stakeholders.

22. The system of claim 1, wherein the plurality of analytical utilities comprises at least one of benchmarking, forecasting, historical data, and scenario generation.
